(19) United States
(12) Patent Application Publication
(10) Pub. No.: US 2012/0110916 A1
(43) Pub. Date: May 10, 2012

(54) EXTRUDABLE POLYMER FOR BONDING METAL TO RUBBER AND THERMOPLASTIC POLYMERS

(76) Inventors: Krishnama Chari Gopalan, Troy, MI (US); Henry Kim, Canton, MI (US); Liggett Cothran, Lambertville, MI (US)

(21) Appl. No.: 12/867,644

(22) PCT Filed: Feb. 17, 2009
(86) PCT No.: PCT/US09/34284

§ 371 Date: Dec. 22, 2011

Related U.S. Application Data
(60) Provisional application No. 61/028,793, filed on Feb. 14, 2008.

(51) Int. Cl. B60J 10/04; C09J 7/00

(52) U.S. Cl. 49/475.1; 49/506

(57) ABSTRACT

A weatherstrip assembly includes a metal surface, a thin tie layer of polymeric material covering at least select portions of the metal surface, and an elastomeric material received over the thin tie layer of polymeric material and exhibiting improved bonding with the metal through the thin layer of polymeric material. Preferably, the thin tie layer is a polypropylene-based olefinic copolymer and an ethylene acrylic acid copolymer.

### BACKGROUND OF THE DISCLOSURE

This application claims priority from U.S. provisional application Ser. No. 61/028,793, filed 14 Feb. 2008.

This disclosure relates to metal and elastomer composite articles, and improving the bonding therebetween, and more specifically to a weatherseal that includes a metal portion or core covered at least in part by an elastomeric material such as rubber, EPDM, or thermoplastic.

It is generally known in the automotive field to provide weatherstrips or weatherseals, such as automotive glass runs, inner belts, outer belts, and similar applications that will be generally referred to herein as a weatherstrip, having a metal core that is at least partially covered by an elastomeric material. Processing lines that manufacture these weatherstrips are extremely long, on the order of hundreds of feet long, so that it is important to find other ways to improve manufacture such as by reducing the processing time and consequently the length of the lines in order to improve efficiency, speed of manufacture, and decrease costs.

In addition, the resultant weatherstrip requires a strong bond or adhesion between the metal and elastomeric material. For example, finish processing steps such as bending or stretching of the weatherstrip require a tenacious bond between these portions of the final component, although other straight or curved applications of the metal at least partially coated in an elastomer require improved bonding also.

In present arrangements, the metal surface of the weatherstrip is preferably cleaned with a solvent solution. The solution cleans oils or surface contaminants from the metal surface. The solution must typically be permitted to dry or cure before at least a portion of the metal surface is coated with an adhesive layer. The adhesive layer is a liquid material applied by dipping, wiping, or brushing onto the clean metal surface. The metal—now coated with the adhesive layer—is then exposed to a drying or curing oven to render the coated part to a dry solid coating on the metal surface. Subsequently, the elastomeric material is provided over the adhesive layer, typically through an extrusion operation where the elastomeric material bonds to the adhesive layer.

Accordingly, a need exists for an improved weatherstrip having better bonding of the elastomeric material, and with improved processing or manufacturability in order to reduce cost, better control of the final product, enhance efficiency of manufacture, reduce scrap, and create a better quality of product.

### SUMMARY OF THE DISCLOSURE

A weatherstrip assembly includes a metal surface, a thin tie layer of polymeric material covering at least select portions of the metal surface, and an elastomeric material received over the thin tie layer of polymeric material and exhibiting improved bonding with the metal through the thin layer of polymeric material.

The thin tie layer preferably has a thickness ranging from approximately 0.0001 inches to approximately 0.125 inches and a material density ranging from 0.93 to 1.1 g/cm³.

In a preferred embodiment, the thin tie layer is a polypropylene-based olefinic copolymer, or alternatively an ethylene acrylic acid copolymer.

The metal surface is preferably one of aluminum, ferrous metal, and a stainless steel.

The elastomeric material is preferably one of an EPDM or thermoplastic vulcanizate (TPV).

The thin tie layer includes at least one additive from the group of a colorant, UV agent, heat stabilizer, coupling agent, and internal lubricant.

A method of forming a weatherstrip assembly includes providing a metal layer, heating the metal layer to approximately 200 to 400 degrees F., coating at least portions of the metal layer with a thin tie layer of polymeric material, and covering at least portions of the metal layer and thin tie layer with an elastomeric material.

The coating step preferably includes extruding the thin tie layer of polymeric material on the metal layer, and more preferably applying the polymeric material at a thickness ranging from approximately 0.0001 inches to approximately 0.125 inches.

The extruding step includes using one of a polypropylene-based olefinic copolymer and an ethylene acrylic acid copolymer.

The metal surface is preferably one of an aluminum, ferrous metal, and stainless steel.

The coating and covering steps include coextruding the thin tie layer and the elastomeric material on the metal layer.

The method further includes adding at least one a colorant, UV agent, heat stabilizer, coupling agent, and internal lubricant.

Still other features and benefits will be found in the following detailed description.

### BRIEF DESCRIPTION OF THE DRAWINGS

FIG. 1 is an isometric view of a weatherstrip.

FIG. 2 is a cross-sectional view taken generally along the lines 2-2 of FIG. 1.

FIG. 3 is a schematic or flow chart representation of the steps involved in manufacturing the weatherstrip.

FIG. 4 is a schematic or flow chart another set of alternative manufacturing steps.

### DETAILED DESCRIPTION OF THE PREFERRED EMBODIMENTS

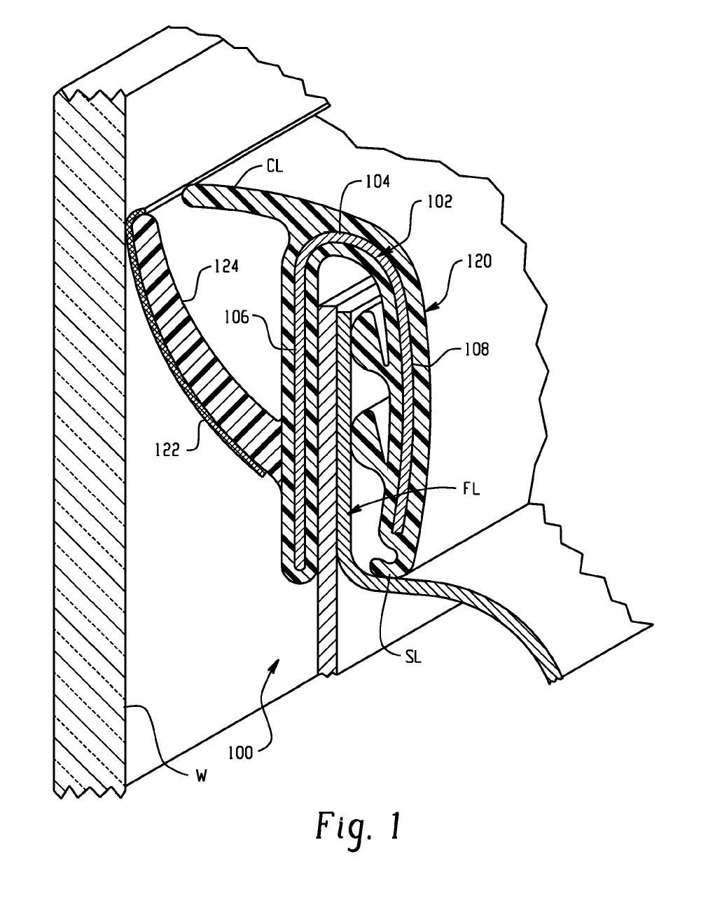

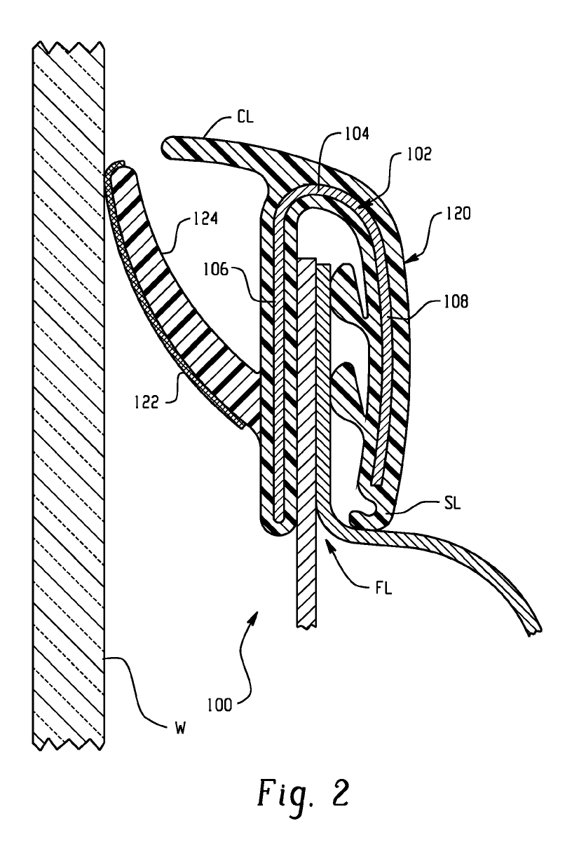

Turning to FIG. 1, a weatherstrip such as a glass run or the illustrated outer belt 100 includes a metal structural layer or interior core 102 that may be a metal material such as aluminum, ferrous metal or in other weatherstrip environments may include a more expensive metal such as stainless steel. For example, the metal is shown as being a generally U-shaped structure in cross-section (FIG. 2) that includes a base portion 104 interconnecting at first ends first and second legs 106, 108 extending outwardly from the base portion. The metal may be a solid core, or alternatively may be lanced at spaced longitudinal locations to aid in bending and conforming the weatherstrip to the automotive vehicle flange FL.

Surrounding at least portions of the metal core is an elastomeric material 120 that in some instances may completely encapsulate the inner core, and in other instances may cover only portions of the core. In either instance, the elastomeric material can be a rubber, EPDM, or a thermoplastic and for ease of reference will be referenced herein as an elastomeric material. The material may also extend and form a cover lip CL, and sealing lip SL where the weatherstrip engages the associated automotive vehicle. Optionally, a slip coat 122 may also be provided, e.g., co-extruded, with the elastomeric material 120 to provide a low friction surface on a seal lip 124 for instance that is disposed in facing, sliding engagement with a window W.

For a number of different reasons, and particularly for finished processing steps such as bending, stretching, etc., the weatherstrip is exposed to mechanical forces that would have a tendency to separate the core and the elastomeric material. Thus, it is important to provide a bond between these materials that is resistive to these forces and provides a strong, tenacious bond between these dissimilar materials. As noted above, past practice has cleaned the metal surface that interfaces with the elastomeric material and then an adhesive layer, usually a liquid material, is applied by dipping, wiping, or brushing onto the clean metal surface. Here, however, a tie layer is provided as a thin layer of polymeric material that is extruded onto the metal to enhance the bonding between the elastomeric material and the metal. A preferred tie layer material includes a polypropylene copolymer or olefinic copolymer, while another preferred tie layer material is an ethylene acrylic acid copolymer. The tie layer is preferably extruded onto the entire surface of the metal or on selected surfaces only. The metal strip is heated to a temperature of approximately two hundred to five hundred degrees Fahrenheit (approximately 200° to 500° F.). The polymeric tie layer is processed at temperatures of approximately two hundred to four hundred degrees Fahrenheit (approximately 200° to 400° F.). Preferred thicknesses range from approximately 0.0001 inches to as high as 0.125 inches. Moreover, a tie layer material density would range from approximately 0.93 to 1.1 g/cm³ depending on the additives and the filler loading level. For example, possible fillers in the tie layer include colorants, UV agents, heat stabilizers, coupling agents, and internal lubricants.

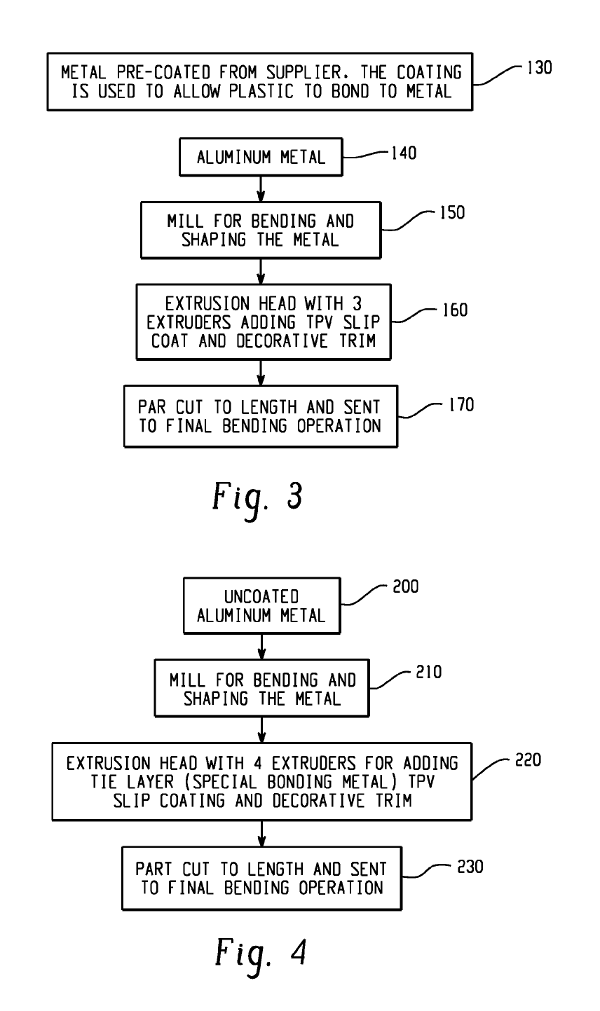

With continued reference to FIGS. 1 and 2, and additional reference to FIG. 3, a preferred method of manufacture will be described in greater detail. Particularly, a previously coated strip of metal is provided as referenced at step 130. A metal supplier may provide the metal to the manufacturer either coated with the tie layer as described above, or the weatherstrip manufacturer may opt to coat the metal with a tie layer prior to introduction into the processing line. In either instance, in the arrangement of FIG. 3, the metal is pre-coated and supplied at step 140 to the weatherstrip processing line. The metal may be flat stock that then is roll formed to shape (e.g., the generally U-shaped shown in the belt weatherstrip of FIGS. 1 and 2) as represented in step 150 and generally described as bending and shaping. The metal is next introduced into an extrusion head at step 160. Since the metal was already coated with the tie layer in the FIG. 3 embodiment, the extrusion head need not accommodate provision for the tie layer. So, for example, the extrusion head in step 160 extrudes an elastomeric material (described in step 160 as a thermoplastic or TPV) on to the metal, and particularly over the tie layer that is already existent on the metal surface. In addition, the slip coat 122 shown in FIGS. 1 and 2 may be coextruded and a decorative trim may also be provided and potentially formed from a different material than the remainder of the elastomeric material and the slip coat. Subsequently, the finished product is cured and cut to length and/or undergoes additional final processing steps such as bending as represented in step 170.

FIG. 4 is a variation of the manufacturing process shown in the line described with reference to FIG. 3. Here, the metal is an uncoated metal such as aluminum, ferrous metal, stainless steel, or other support or core metals commonly used in weatherstrip environments. As referenced in step 200, the metal is uncoated, i.e., there is no tie layer or thin layer of polymeric material as used in connection with the FIG. 3 arrangement. The metal is similarly formed, bent, and shaped into the desired conformation in step 210. The metal is subsequently introduced into the extrusion head at step 220 where up to four extrusions, for example, are provided on the metal surface. The special bonding material or tie layer is extruded along with the elastomeric material, the slip coating (if needed) and any decorative trim material, again, if needed in the particular application. Preferably these materials are coextruded for reasons of efficiency, however, serial extrusions (i.e., back-to-back extrusions) in a single line are not outside the scope of the present disclosure although not as preferred. Subsequently, the coextruded component is cut to length and sent to final bending and processing operations as represented by step 230.

The primary difference between FIGS. 3 and 4 is that, in the embodiment of FIG. 4, all of the bonding materials are completed or done in an online all-in-one extrusion operation. However, one skilled in the art will appreciate that it is also possible to add the tie layer in an off line operation. The off line operation can be used to increase the output of the tie layer metal operation and then use the coated aluminum or other metals to add different materials, lines, rubber or thermoplastic materials.

This material may be used to coat metal strips to allow rubber or thermoplastic to bond to the metal cross section. The thermoplastic material would act as a tie layer to improve the adhesion of the polymers before finish processing such as bending or stretching into the final shape. This application is preferable for automotive glass run channels, inner belts, outer belts and other applications.

The disclosure has been described with reference to the preferred embodiment. Modifications and alterations will occur to others upon reading and understanding this specification. It is intended to include all such modifications and alterations in so far as they come within the scope of the appended claims or the equivalents thereof.

Having thus described the disclosure, we claim:

1. A weatherstrip assembly comprising:
a metal surface;
a thin tie layer of polymeric material covering at least select portions of the metal surface; and
an elastomeric material received over the thin tie layer of polymeric material and exhibiting improved bonding with the metal through the thin layer of polymeric material.

2. The weatherstrip assembly of claim 1 wherein the thin tie layer has a thickness ranging from approximately 0.0001 inches to approximately 0.125 inches.

3. The weatherstrip assembly of claim 2 wherein the thin tie layer is a polypropylene-based olefinic copolymer.

4. The weatherstrip assembly of claim 2 wherein the thin tie layer is an ethylene acrylic acid copolymer.

5. The weatherstrip assembly of claim 1 wherein the thin tie layer is a polypropylene-based olefinic copolymer.

6. The weatherstrip assembly of claim 2 wherein the thin tie layer is an ethylene acrylic acid copolymer.

7. The weatherstrip assembly of claim 1 wherein the metal surface is aluminum.

8. The weatherstrip assembly of claim 1 wherein the metal surface is a ferrous metal.

9. The weatherstrip assembly of claim 1 wherein the metal surface is stainless steel.

10. The weatherstrip assembly of claim 1 wherein the elastomeric material is EPDM.

11. The weatherstrip assembly of claim 1 wherein the elastomeric material is a thermoplastic vulcanizate (TPV).

12. The weatherstrip assembly of claim 1 wherein the thin tie layer includes at least one additive from the group of a colorant, UV agent, heat stabilizer, coupling agent, and internal lubricant.

13. The weatherstrip assembly of claim 1 wherein the thin tie layer has a material density ranging from 0.93 to 1.1 g/cm³.

14. A method of forming a weatherstrip assembly comprising:
providing a metal layer;
heating the metal layer to approximately 200 to 400 degrees F.;
coating at least portions of the metal layer with a thin tie layer of polymeric material; and
covering at least portions of the metal layer and thin tie layer with an elastomeric material.

15. The method of claim 14 wherein the coating step includes extruding the thin tie layer of polymeric material on the metal layer.

16. The method of claim 15 wherein the extruding step applies the polymeric material at a thickness ranging from approximately 0.0001 inches to approximately 0.125 inches.

17. The method of claim 15 wherein the extruding step includes using one of a polypropylene-based olefinic copolymer and an ethylene acrylic acid copolymer.

18. The method of claim 14 wherein the coating and covering steps include coextruding the thin tie layer and the elastomeric material on the metal layer.

19. The method of claim 14 wherein the metal layer providing step includes using one of an aluminum, ferrous metal, and stainless steel.

20. The method of claim 14 further comprising including at least one additive from the group of colorants, UV agents, heat stabilizers, coupling agents, and internal lubricants.
